(19) United States
(12) Patent Application Publication
(10) Pub. No.: US 2017/0167437 A1
(43) Pub. Date: Jun. 15, 2017

(54) JET ENGINES AND THEIR ARRANGEMENT IN THE REAR SECTION OF AN AIRCRAFT

(71) Applicant: Airbus Operations SAS, Toulouse (FR)

(72) Inventors: Olivier Cazals, BLAGNAC (FR); Julien GUILLEMAUT, TOULOUSE (FR)

(21) Appl. No.: 15/378,739

(22) Filed: Dec. 14, 2016

(30) Foreign Application Priority Data
Dec. 15, 2015 (FR) 1562341

(51) Int. Cl. F02K 1/52; F02K 1/56

(52) U.S. Cl. CPC F02K 1/52; F02K 1/566; F05D 2220/323; F05D 2250/314

(57) ABSTRACT

A jet engine comprises at least three zones including an air intake zone and an exhaust zone. The axis of the air intake zone is not coincident with the axis of the exhaust zone of the engine, the engine as a result, having at least two intersecting axes and being referred to as a multiaxial engine. Therefore, the jet engine has at least two zones with different longitudinal axis orientations: by choosing an axial orientation of the zones of the engine that are more sensitive to a detachment or breakage of elements of the gas generator, it is possible to also choose a direction of the possible paths of these detached elements, to avoid them striking the opposite engine.

### CROSS-REFERENCES TO RELATED APPLICATIONS

This application claims the benefit of the French patent application No. 1562341 filed on Dec. 15, 2015, the entire disclosures of which are incorporated herein by way of reference.

### BACKGROUND OF THE INVENTION

The present invention concerns the field of jet engines and the arrangement thereof in the rear section of an aircraft. The present invention relates to a novel type of jet engine, to the rear section of the aircraft bearing the jet engines, to the method for producing the rear section, and to the aircraft having such a rear section. It applies more particularly to commercial airplanes.

The present invention relates to aircraft equipped with two jet engines, also referred to as turbofans, that are fitted in the rear section of the fuselage on either side of the fuselage.

The rear section of the fuselage comprises a section of variable cross section that bears the empennage and is situated at the rear of the aircraft at the opposite end from the cockpit in a configuration of the conventional type.

The application EP 11382409.8, filed by the present applicant on Dec. 28, 2011, describes an aircraft in which two engines are arranged at the rear on either side of the fuselage. FIG. 3 illustrates, for example, jet engines that are semi-buried on either side of a plane of symmetry of the fuselage. The engines of the semi-buried type have the advantage of being able to ingest a part of the boundary layer and to improve the performance thereof.

However, because they are partially buried, the distance between them decreases. As a result, the risk of being impacted by an event of the UERF (Uncontained Engine Rotor Failure) type increases. An event of the UERF type is characterized by the detachment of an internal part of the jet engine, which will directly or indirectly strike the fuselage or the opposite engine. A solution for avoiding this that has been proposed by the present applicant in another patent application comprises providing an internal shield positioned in a vertical plane of symmetry of the fuselage.

However, the addition of a shield having a sufficiently solid structure increases the weight of the airplane. It also makes it necessary, given its bulk, to revise the internal organization of the tail of the airplane so as to allow it to be fitted.

The applications WO2014/074149 and US2014/025216 describe an air intake zone and an exhaust zone, the axis of the air intake zone not being coincident with the axis of the exhaust zone. In the application WO2014/074149, the air intake zone corresponds to a simple opening in the fuselage of the airplane. In the application US2014/0252161, the two parts of the engine of non-coincident axes are connected by a shaft which drives propellers located on the axis of the exhaust zone.

The aim of the present invention is to propose a novel type of jet engine providing an alternative that makes it possible to increase the ingestion of the boundary layer and thus the performance of the engine, while remedying the problem of UERF or any equivalent problem without resorting to fitting a shield.

### SUMMARY OF THE INVENTION

To this end, the present invention proposes a jet engine comprising at least three zones including an air intake zone and an exhaust zone, wherein the axis of the air intake zone is not coincident with the axis of the exhaust zone of the engine, the engine as a result having at least two intersecting axes and being referred to as a multiaxial engine.

Thus, the jet engine has at least two parts with different longitudinal orientations: by choosing the orientation of the zones of the engine that are more sensitive to the detachment or breakage of elements of the gas generator, this makes it possible to also choose the direction of the possible paths of these detached elements. Thus, when the engine is positioned on the rear section of an aircraft in the region of its variable cross section, a suitable orientation having been chosen for certain zones of the engine, the direction of the paths of the detached elements does not meet the engine disposed on the other side of the rear section of the fuselage.

The jet engine has at least one of the following optional features, considered in isolation or in combination.

The axis of the air intake zone and the axis of the exhaust zone are parallel.

The jet engine comprises a driving zone; the axis of the driving zone is neither parallel to nor coincident with the axes of the air intake zone and of the exhaust zone, the engine thus having three different axes.

The jet engine comprises a compression zone and a combustion zone; the axes of the driving zone, of the compression zone and of the combustion zone are coincident.

The present invention also relates to an aircraft rear section having a fuselage section of variable cross section comprising at least two jet engines positioned on either side of the section and comprising at least three zones including an air intake zone and an exhaust zone, the axis of the air intake zone not being coincident with the axis of the exhaust zone of the engine, the engine as a result having at least two intersecting axes and being referred to as a multiaxial engine, wherein the axis/axes of further zones of the multiaxial jet engine is/are oriented such that one or more surface(s) delineating trajectories of detached elements of each jet engine do(es) not meet the opposite jet engine.

The aircraft rear section has at least one of the following optional features, considered in isolation or in combination.

The surface comprises a cone representative of a UERF event that is established for a driving zone of the engine.

The shape of the fuselage and/or the shape and position of the various means for securing the jet engines to the fuselage are determined so as to allow the zone(s) contained between the air intake zone and the exhaust zone of the motors to follow the contour of the fuselage and to orient the delineating surface(s).

The exhaust zone of the engine and the exhaust zone of the other engine are merged so as to form only one exhaust zone positioned at the rear end of the section.

The exhaust zone is provided with a thrust reverser system.

The present invention also relates to the aircraft provided with such a rear section.

The present invention also relates to a method for producing an aircraft rear section having a variable cross section, bearing at least two jet engines comprising at least three zones including an air intake zone and an exhaust zone, the axis of the air intake zone not being coincident with the axis of the exhaust zone of the engine, the engine as a result having at least two intersecting axes and being referred to as a multiaxial engine, wherein the method comprises a step in which the engines are positioned on either side of the variable section such that one or more surface(s) delineating trajectories of detached elements of each jet engine do(es) not meet the opposite jet engine.

The method comprises a step in which the orientation of the axes of the multiaxial engines is chosen and the shape of the fuselage and/or the shape and position of the various means for securing the jet engines to the fuselage is/are modified in order to make it possible to orient the delineating surface(s) and the engines with respect to the contour of the fuselage.

### BRIEF DESCRIPTION OF THE DRAWINGS

Further aims, advantages and features of the invention will become apparent from reading the following description of the jet engine and of the rear section of an aircraft provided with such an engine according to the invention, given by way of nonlimiting example with reference to the appended drawings, in which:

FIG. 1 shows a schematic side view in cross section of a jet engine of known type;

FIG. 2 shows a schematic top view in cross section of an aircraft rear section provided on either side with two jet engines according to one embodiment of the invention;

FIG. 3 shows a schematic top view in cross section of an aircraft rear section provided on either side with two jet engines according to another embodiment of the invention;

FIG. 4 shows a schematic top view in cross section of an aircraft rear section provided on either side with two jet engines according to another embodiment of the invention;

FIGS. 5a to 5d show a comparison of the impact of a UERF event on a rear section according to the prior art and on a rear section according to the embodiments in FIG. 2 and FIG. 3.

### DETAILED DESCRIPTION OF THE PREFERRED EMBODIMENTS

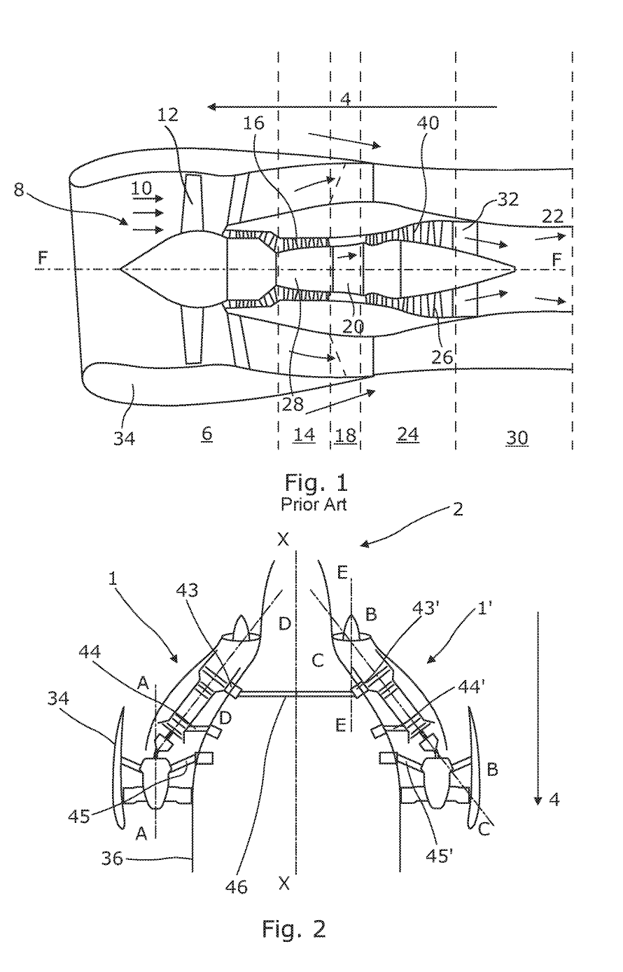

As shown in FIG. 1, the present invention relates to an aircraft jet or turboprop engine 1 in which air is drawn in and compressed in order then to be mixed with a fuel, the combustion of which brings about great expansion of the gases: the exhaust of the gases provides the thrust for moving the aircraft forward but also for setting in motion the compressor that effects the compression.

Throughout the following description, by convention, the direction X-X corresponds to the longitudinal direction of the aircraft, which is akin to the longitudinal direction of the rear section 2 thereof.

Moreover, the terms “front” and “rear” should be considered with respect to a direction of forward travel of the aircraft encountered as a result of the thrust exerted by the jet engines 1, this direction being represented schematically by the arrow 4.

The jet engine 1 has at least five zones:

an air intake zone 6 comprising an air intake 8 which orients the penetration of air into the engine, represented by the arrows 10, and in which a propeller 12, referred to as a fan, for drawing in air is housed;

a compression zone 14 provided with a compressor 16 for progressively increasing the pressure of the air drawn in;

a combustion zone 18 including a combustion chamber 20 in which the fuel is injected into the compressed air, causing the combustion thereof and the violent rearward ejection of hot gases, represented by the arrows 22;

a driving zone 24 comprising a turbine 26 that is driven by the ejection 22 of hot gases and in turn allows the propeller 12 and the compressor 16, to which the turbine is linked by a shaft 28, to be set in motion;

an exhaust zone 30 having an exhaust nozzle 32 that regulates the outlet of the gases 22 providing the thrust for moving the aircraft forward, represented by the arrow 4.

In the rest of the description, an axis of a zone will be considered to be the longitudinal central axis of partial or full symmetry of the components or of a part of the components of this zone. If a zone happens not to have any components having an axis of partial or total central symmetry, the axis of an adjacent zone will be considered.

Thus, for example, the axis A-A of the air intake zone 6 in the examples illustrated in FIGS. 1 to 5 is not an axis of symmetry of the nacelle 34 at the air intake. The engine has a semi-buried configuration. In such a configuration, a part of the nacelle 34 of the jet engine 1 is formed by the fuselage 36 and, as a result, the nacelle 34 does not have a symmetrical shape, unlike the engine in FIG. 1. As a result, the axis A-A of the air intake is formed by the rotor axis of rotation of the fan 12, since it forms an axis of symmetry for the fan 12.

The axis B-B of the compression zone 14 is formed by the axis of the compressor 16 and more specifically the axis of rotation of the vanes 38 (blade or the like) that it bears.

The axis C-C of the combustion zone 18 is the axis of longitudinal symmetry of the combustion chamber 20. When the chamber has a shape without a central longitudinal axis of symmetry, the axis of the combustion chamber is the axis of the compression zone 14 and/or of the driving zone 24.

The axis D-D of the driving zone 24 is formed by the axis of the turbine 26 and more specifically by the axis of the blades 40 of the turbine 26.

The axis E-E of the exhaust zone 30 is formed by the axis of the outlet of the nozzle 32.

In motors of known type, the axes A-A of the air intake zone, B-B of the compression zone, C-C of the combustion zone, D-D of the driving zone and E-E of the exhaust zone are all coincident along one and the same axis F-F, as shown in FIG. 1. The zones follow one another and are centered about one and the same longitudinal axis.

In order to afford a novel configuration engine that makes it possible to address the problem set out above, the axis of the air inlet zone 6 is not coincident with the axis of the exhaust zone 30. As a result, if the axes of these end zones are not coincident, it follows that there is at least one zone in which the axis intersects at least one of the axes of the end zones in order to be connected up. As a result, the jet engine is therefore multiaxial since the various zones of which it is made up have at least two different non-coincident axes which intersect one another. The jet engine 1 does not have an elongate shape centered on a single axis (F-F in the prior art illustrated). The various components of the jet engine are not centered on one and the same axis. The axis of one or more zones is different than the axis of one or more other zones. The engine has at least two zones that are oriented in a different longitudinal direction.

The engine has zones at which elements can break or detach given, for example, the vibrations or other thermomechanical effects produced in these zones during operation of the engine. Thus, for example, the rotational movement of the turbine of a very high speed engine can cause the detachment by breakage or unsticking or the like, of elements, pieces, debris or the like, these being referred to as detached elements in the following text. The analysis of these zones leads to the identification of the paths followed by these detached elements. Thus, for the turbine of a jet engine, for example, it is known that the detached elements are contained in a geometric surface having a conical shape known as a cone. The surface could have any other shape and will be referred to in a general manner in the following text as a surface delineating the paths of detached elements.

According to one embodiment, such as those illustrated in FIGS. 2 to 5, the axes A-A of the air intake zone and E-E of the exhaust zone are parallel but not coincident. The axis of the driving zone 24 is neither parallel to nor coincident with the axes of the air intake zone 6 and of the exhaust zone 30. Only the axes B-B of the compression zone 14, C-C of the combustion zone 18 and D-D of the driving zone are coincident. The axes A-A and E-E, for the one part, and B-B, C-C and D-D, for the other part, intersect and form an angle other than 90° or 180°.

The present invention relates to the field of aircraft of which the rear section 2 has a variable cross section. The rear section 2 of the aircraft according to the invention that is shown schematically in FIGS. 2 to 5 has a central longitudinal axis X-X through which a vertical plane of symmetry passes when the aircraft is on the ground in a horizontal position. The rear section 2 bears two jet engines 1, 1′ disposed on either side of the plane of symmetry passing through the longitudinal axis X-X.

In all of the configurations illustrated in FIGS. 2 to 5, the jet engines 1, 1′ are positioned on either side of the rear section 2 of the aircraft along axes A-A of the air intake zone and E-E of the exhaust zone that are parallel to the longitudinal axis X-X of the rear section 2 of the aircraft. As a result, the air drawn in by the jet engines 1, 1′ is released parallel to the air drawn in and to the air drawn in and ejected by the other jet engine 1′, 1, respectively, and parallel to the axis X-X of the aircraft, ensuring that the aircraft moves in rectilinear translation along the arrow 4.

As shown in FIGS. 2 to 5, the jet engines 1, 1′ are positioned along the rear section of the aircraft of variable cross section. In order to be able to follow the lines of the fuselage 36 and determine the orientation of the surface(s) delineating the paths of detached elements, the jet engine 1, 1′ is a multiaxial engine as set out above.

One or more zones of the jet engine corresponding to the sensitive zone(s) of the engine are positioned along one or more axes making it possible to orient the delineating surface(s) such that they do not meet the opposite jet engine.

It is also possible to modify other parameters, such as the shape of the fuselage and more specifically the curvature of the variable cross section or the shape, and notably the length, of the various means for securing the jet engine to the fuselage or the positions thereof thereon.

According to the embodiments shown on FIGS. 2 to 5, the axis of the air intake zone 6 is parallel to, but not coincident with, that of the exhaust zone 30 and these two axes A-A and E-E are neither parallel to, nor coincident with, those of the other zones. Each axis B-B, C-C and D-D intersects the axes A-A and E-E, respectively.

In this way, the air intake zone 6 is substantially parallel to the axis X-X of the rear section 2 and can be positioned closest thereto in order to increase the ingestion of the boundary layer.

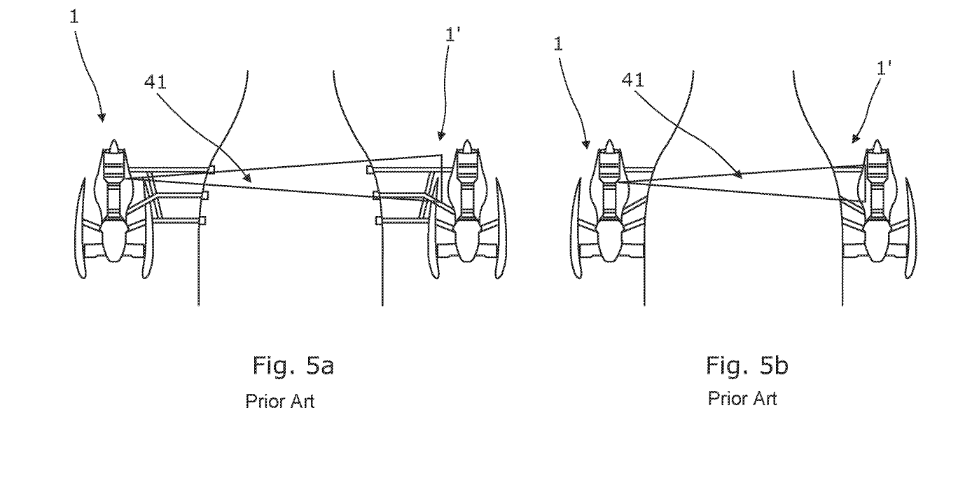

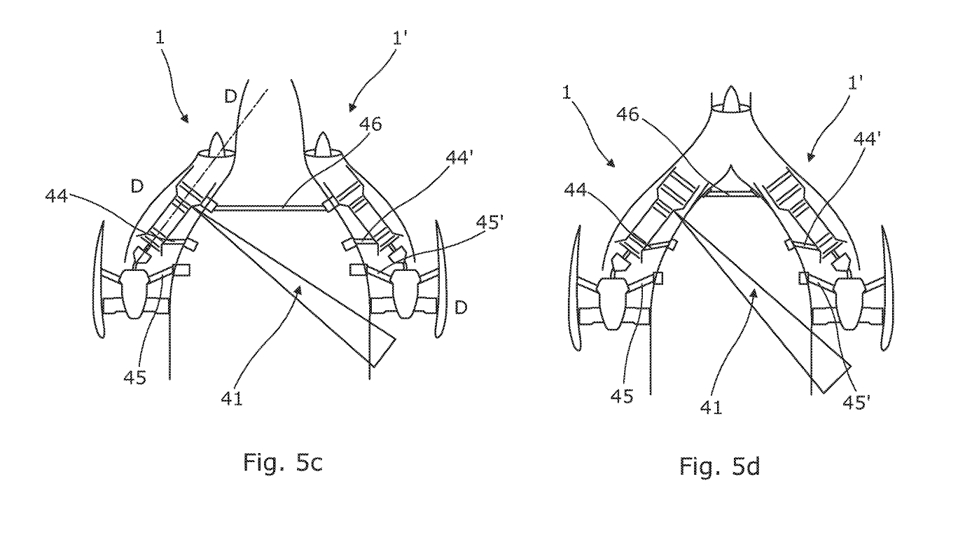

As shown in FIGS. 5a, and 5b, each jet engine 1, 1′ has an established surface delineating the paths of detached elements that is representative of a UERF event and in the form of a cone 41. The cone 41 defines, as seen above, the surface inside which all of the different possible paths followed by detached elements of the jet engine, and notably of the turbine 26, are located. In the prior art, as shown in FIGS. 5a and 5b, the position of the cone 41 is such that detached parts of a jet engine 1 could strike the opposite jet engine 1′.

In the present invention, as shown in FIGS. 5c and 5d, the axis D-D of the driving zone 24 is oriented such that the cone 41 representative of a UERF event for each of the jet engines 1, 1′ does not intersect, does not cross the other jet engine 1, 1′. Thus, in the event of detachment or breakage of an element of the turbine and/or of an element of the blades of the turbine of a jet engine 1, 1′, respectively, the detached elements cannot damage or destroy the other jet engine 1, 1′.

The shape of the cone 41 representative of a UERF event depends on the jet engine 1. Depending on the shape of the cone, the axis of the driving zone 24 of the corresponding jet engine 1 or 1′ is determined such that the cone does not meet the other jet engine 1′ or 1, respectively, and is thus positioned entirely upstream of the jet engine. It is also possible, as seen above, to modify other parameters such as the shape of the rear section, like the curvature of the variable cross section 42 of the fuselage, or the shape, and notably the length, of the various means 43, 43′, 44, 45, 44′, 45′ for securing the jet engine to the fuselage or the positions thereof thereon. All of these parameters are chosen so as to make it possible to position the cone as desired while positioning the jet engine along the rear section of variable cross section.

In all of the embodiments illustrated in FIGS. 2 to 5, the means for securing the jet engine 1 and 1′ to the fuselage are in the form of three fasteners (43, 44, 45) and (43′, 44′, 45′), respectively.

The first fastener allows the driving zone 24 of the jet engine 1, 1′ to be directly secured, by way of a link 43, 43′, to the rear section 42 of variable cross section of the fuselage. The fasteners 43, 43′ are connected by a link rod 46 passing through the inside of the rear section 42 of variable cross section of the fuselage.

The second fastener allows the compression zone 14 of the jet engine 1, 1′ to be secured by way of a link rod 44, 44′ to the rear section 42 of variable cross section of the fuselage.

The third fastener allows the air intake zone 6 of the jet engine 1, 1′ to be secured by way of a link rod 45, 45′ to the rear section 42 of variable cross section of the fuselage.

In the embodiment in FIG. 2, the first fastener is secured at a frame of the fuselage. The third fastener is likewise secured at a frame of the fuselage.

The second fastener can be removed: it makes it possible to strengthen the retention of the jet engine.

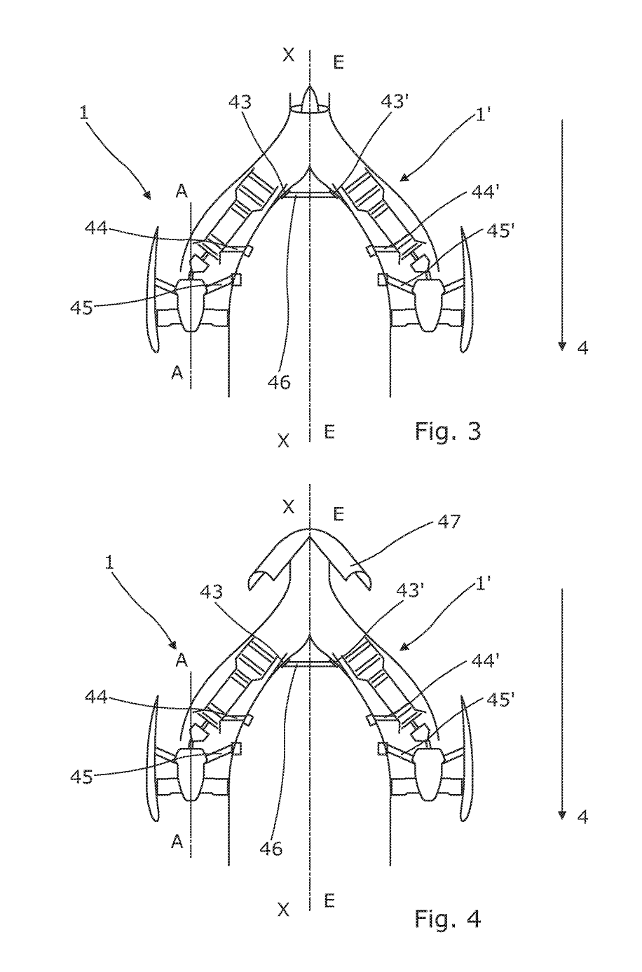

The additional and distinctive features of the embodiments of FIGS. 3 and 4 compared with that of FIG. 2 are the following:

the exhaust zones 30 of the jet engines 1, 1′ are merged to form only one: the exhaust zone is thus positioned at the rear end of the rear section on the axis X-X thereof. The axis E-E of the exhaust zone 30 is coincident with the axis X-X of the rear section.

This makes it possible to have only one nozzle rather than two. This results in a saving of weight, of bulk, of manufacturing cost, maintenance, etc.

In the embodiment of FIG. 4 compared with that of FIG. 3, the zone 30 is provided with a thrust reverser system 47 which again makes it possible to obtain the advantages set out above. The thrust reverser system is a system of known type for example in the form of two flaps articulated to the edge of the nozzle of the exhaust zone.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A jet engine comprising:
at least three zones including an air intake zone, an exhaust zone and a driving zone,
an axis of the air intake zone being non-coincident with an axis of the exhaust zone, the engine, as a result, having at least two intersecting axes and being referred to as a multiaxial engine,
an axis of the driving zone being neither parallel to, nor coincident with, the axes of the air intake zone and of the exhaust zone, the engine thus having three different axes.

2. The jet engine as claimed in claim 1, wherein the axis of the air intake zone and the axis of the exhaust zone are parallel.

3. The jet engine as claimed in claim 1, further comprising a compression zone with an axis and a combustion zone with an axis, and wherein the axes of the driving zone, the compression zone and the combustion zone are coincident.

4. An aircraft rear section comprising:
a fuselage section of variable cross section,
at least two jet engines being positioned on either opposite side of said fuselage section, said engines each comprising at least three zones including an air intake zone, an exhaust zone and a driving zone,
an axis of the air intake zone being non-coincident with an axis of the exhaust zone, the engine, as a result, having at least two intersecting axes and being referred to as a multiaxial engine,
an axis of the driving zone being neither parallel to, nor coincident with, the axes of the air intake zone and of the exhaust zone, the engine thus having three different axes,
at least one of the at least three zones, other than the air intake zone and the exhaust zone, comprising elements which may become detached from the jet engine during operation, the detached elements having potential trajectories which define a volume with one or more surfaces extending outwardly from the respective zone of the jet engine, and
wherein the axis of the at least one of the at least three zones of each engine being oriented such that the one or more surfaces delineating potential trajectories of the detached elements does not intersect with the opposite jet engine.

5. The aircraft rear section as claimed in claim 4, wherein the surface comprises a cone representative of a UERF event that is established for the driving zone of said engine.

6. The aircraft rear section as claimed in claim 4, wherein at least one of:
a shape of the fuselage, or
a shape and position of elements securing the jet engines to the fuselage,
are determined so as to allow at least one zone located between the air intake zone and the exhaust zone of said engines to follow a contour of the fuselage and to orient the one or more delineating surfaces.

7. The aircraft rear section as claimed in claim 4, wherein the exhaust zones of the two engines are merged so as to form only one exhaust zone positioned at a rear end of said aircraft rear section.

8. The aircraft rear section as claimed in claim 7, wherein the exhaust zone is provided with a thrust reverser system.

9. An aircraft comprising a rear section as claimed in claim 4.

10. A method for producing an aircraft rear section having a variable cross section and bearing at least two jet engines, each engine comprising at least three zones including an air intake zone and an exhaust zone, an axis of the air intake zone not being coincident with an axis of the exhaust zone of said engine, the engine, as a result, having at least two intersecting axes and being referred to as a multiaxial engine, wherein the engines further comprise a driving zone, and wherein an axis of the driving zone is neither parallel to nor coincident with the axes of the air intake zone and of the exhaust zone, the engines thus having three different axes, and wherein the method comprises:
positioning the engines on either side of said variable cross section such that one or more surfaces delineating potential trajectories of detached elements of each jet engine do not intersect with the opposite jet engine.

11. The method as claimed in claim 10, further comprising choosing the orientation of the axes of the multiaxial engines and modifying at least one of a shape of the fuselage or a shape and position of elements securing the jet engines to the fuselage in order to orient the one or more delineating surfaces and the engines with respect to the contour of the fuselage.
